(19) United States
(12) Patent Application Publication
(10) Pub. No.: US 2026/0289392 A1
(43) Pub. Date: Sep. 24, 2026

(54) VALIDATION OF RESPONSES GENERATED BY LANGUAGE MODELS

(71) Applicant: International Business Machines Corporation, Armonk, NY (US)

(72) Inventors: Paulina Toro Isaza, White Plains, NY (US); Ting Dai, Tampa, FL (US); Simao Liu, San Jose, CA (US); Ruchi Mahindru, Elmsford, NY (US); Yu Deng, Yorktown Heights, NY (US); Chandrasekhar Narayanaswami, Wilton, CT (US); Larisa Shwartz, Greenwich, CT (US)

(21) Appl. No.: 19/086,737

(22) Filed: Mar. 21, 2025

(51) Int. Cl. G06N 20/00

(52) U.S. Cl. CPC G06N 20/00

(57) ABSTRACT

Validation of responses generated by a language model is provided and includes identifying, via machine learning, first entity action pairs from a first response of a generative language machine learning model. Each of the first entity action pairs includes a respective entity and a respective action associated with the respective entity. A first validation score is determined based on whether the first entity action pairs are present within a first knowledge base and a second set of validation scores is determined based on whether the first entity action pairs are present within a second knowledge base. A first final validation score is generated based on the first validation score and the second set of validation scores. A first recommendation from the first response is presented based on the first final validation score and operations are controlled based on the presented first recommendation.

### BACKGROUND

The disclosure relates to generative machine learning models, to language models, to evaluating responses generated by language models, and to using generative machine learning models to perform artificial intelligence for information technology operations (AIOps).

### SUMMARY

In various embodiments of the disclosure, a computer-implemented method for validation of domain-specific responses generated by language models is described. The computer-implemented method includes identifying, via machine learning, first entity action pairs from a first response of a generative language machine learning model. Each of the first entity action pairs includes a respective entity and a respective action associated with the respective entity. The computer-implemented method further includes determining, via machine learning, a first validation score based on whether the first entity action pairs are present within a first knowledge base. The computer-implemented method further includes determining, via machine learning, a second set of validation scores based on whether the first entity action pairs are present within a second knowledge base. The computer-implemented method further includes generating a first final validation score based on the first validation score and the second set of validation scores. The computer-implemented method further includes presenting a first recommendation from the first response based on the first final validation score. The computer-implemented method further includes controlling, by a computer, operations based on the presented first recommendation.

A computer program product and a computer system corresponding to the above method are also disclosed herein.

Additional technical features and benefits are realized through the processes of the disclosure. Embodiments and aspects of the disclosure are described in detail herein and are considered a part of the claimed subject matter. For a better understanding, refer to the detailed description and the drawings.

### BRIEF DESCRIPTION OF THE DRAWINGS

The following description will provide details of preferred embodiments with reference to the following figures wherein:

FIG. 1 is a diagram that illustrates a computing environment for validation of domain-specific responses generated by language models, in accordance with an embodiment of the disclosure;

FIG. 2 is a diagram that illustrates a network environment for validation of domain-specific responses generated by language models, in accordance with an embodiment of the disclosure;

FIG. 3 is a diagram that illustrates first exemplary operations for validation of domain-specific responses generated by the language model, in accordance with an embodiment of the disclosure;

FIG. 4 is a diagram that illustrates exemplary operations for the determination of a first validation score of a first set of validation scores, in accordance with an embodiment of the disclosure;

FIG. 5A is a diagram that illustrates an exemplary first set of operations for the determination of a second validation score of the first set of validation scores, in accordance with an embodiment of the disclosure;

FIG. 5B is a diagram that illustrates an exemplary second set of operations for the determination of a second validation score of the first set of validation scores, in accordance with an embodiment of the disclosure;

FIG. 6 is a diagram that illustrates exemplary operations for the determination of a second set of validation scores, in accordance with an embodiment of the disclosure;

FIG. 7A is a diagram that illustrates an exemplary user interface (UI) for displaying a first recommendation associated with the response, in accordance with an embodiment of the disclosure;

FIG. 7B is a diagram that illustrates another exemplary UI for displaying a second recommendation associated with the response generated by the language model, in accordance with an embodiment of the disclosure; and

FIG. 8 is a diagram that illustrates a flowchart of an exemplary method for validation of domain-specific responses generated by the language model, in accordance with an embodiment of the disclosure.

### DETAILED DESCRIPTION

The field of artificial intelligence and machine learning has made significant progress, particularly with the development of language models that generate responses like human language. The language models have become widely used across domains such as information technology (IT), healthcare, finance, legal analysis, and customer service environments. Additionally, generative AI can be utilized to perform domain-specific tasks and troubleshoot issues related to the specific domain. Manual validation methods to resolve issues are often inefficient and error-prone. However, using language models in domain-specific environments presents significant challenges such as producing inaccurate or irrelevant output.

Traditional methods to validate domain-specific responses often rely on natural language processing (NLP) evaluation methods to determine the trustworthiness of particular responses in a specific domain. These methods require a ground truth reference (e.g. domain-specific database) to compare with responses and to determine the trustworthiness of the response. Additionally, the absence of a domain-specific database makes it difficult to rely on the responses generated by the language model in the specific domain.

In domain-specific settings, validating the response generated by the language model corresponds to the determination of the trustworthiness of the response. The trustworthiness of the response plays a significant role in ensuring the accuracy and reliability of the response. In scenarios that involve automated systems (e.g. cloud-based IT management systems), inaccuracies or unchecked recommendations associated with domain-specific operations lead to system misconfigurations, security issues, or downtime. In such cases, the validation of domain-specific responses generated by the language models prevents system failures.

Traditional approaches to validate generated responses involve manual review and domain expertise. These traditional approaches needed manual interventions to validate the generated responses of the language models. However, due to these manual interventions, such traditional approaches are inefficient, cumbersome, prone to human errors, and not able to scale to meet the needs of modern domain-specific environments. Moreover, the output generated by the language models mixes actionable insights with irrelevant information, increasing the troubleshooting burden for the experts and making it difficult to extract precise recommendations.

Further, these traditional approaches need a presence of domain-specific experts within organizations for the validation of the responses generated by the language models which makes the traditional approaches inefficient. Moreover, these traditional approaches involve several complex operations such as reception of manual expertise and analysis of the manual expertise to validate the response generated by the language models, which in turn increases the overall processing time to validate the response generated by the language models and makes the overall process cumbersome and prone to human errors.

The disclosed system provides a structured validation process for validating the responses generated by the language models in domain-specific environments. The system provides a way to enhance the efficiency of domain-specific systems to generate trustworthy responses by enabling the validation of domain-specific responses generated by the language model. The disclosed system processes the responses to determine the trustworthiness of generated responses by employing multiple layers of validation and assigning validation scores to each layer to generate the final validation score. Based on the final validation score, the disclosed system controls the execution of the set of operations included in the response.

The disclosed system further utilizes one or more data sources to determine the trustworthiness of the response. In this way, the disclosed system leads to operational efficiency by eliminating the need for manual intervention.

The disclosed system further provides a way to validate the responses in specific domains where ground truth referencing is not present. By utilizing a structured approach, the disclosed system can be utilized in any domain where validation of responses generated by the language model is vital to prevent operational failure. Further, the disclosed system provides a way for organizations to adopt language models in domain-specific environments with greater confidence and to leverage automation to improve efficiency, reduce operational risks, and optimize decision-making based on the determination of the trustworthiness of the responses generated by the language models.

The disclosed system automates the process of validation of responses generated by the language models that in turn eliminates the possibilities of human errors and makes the process of validation more accurate. The disclosed system further reduces the overall processing time to validate the responses generated by the language models by eliminating the need for the reception of the manual expertise, and the analysis of the manual expertise. The disclosed system further eliminates the need for presence of the domain-specific experts within the organizations to validate the generated by the language models by automating the process, making the process more accurate, and eliminating the need for manual interventions.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks are performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium is an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or various freely propagating electromagnetic waves, electromagnetic waves propagating through a waveguide, light pulses passing through a fiber optic cable, electrical signals communicated through a wire, and/or various transmission media. As will be understood by those of skill in the art, data is typically moved at some occasional points in time during operations of a storage device, such as during access, de-fragmentation, or garbage collection, but this does not render the storage device as transitory because the data is not transitory while it is stored.

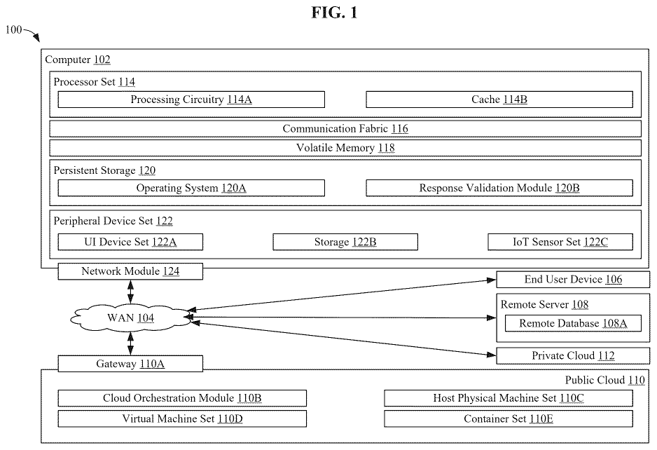

FIG. 1 is a diagram that illustrates a computing environment for validation of domain-specific responses generated by the language model, in accordance with an embodiment of the disclosure. With reference to FIG. 1, there is shown a computing environment 100 that contains an example of an environment for the execution of at least some of the computer code involved in performing the disclosed methods, such as a response validation module 120B. In addition to the response validation module 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the response validation module 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 can take the form of a desktop computer, a laptop computer, a tablet computer, a smartphone, a smartwatch or a wearable computer, a mainframe computer, a quantum computer, or any various forms of a computer or a mobile device now known or to be developed in the future that is configured for running a program, accessing a network or querying a database, such as a remote database 108A. As is well understood in the art of computer technology, and depending upon the technology, the performance of a computer-implemented method can be distributed among multiple computers and/or between multiple locations. In this presentation of the computing environment 100, detailed discussion is focused on a single computer, specifically the computer 102, to keep the presentation as simple as possible. The computer 102 can be located in a cloud, even though it is not shown in a cloud in FIG. 1.

The processor set 114 includes one, or more, computer processors of any type now known or to be developed in the future. The processing circuitry 114A can be distributed over multiple packages, for example, multiple, coordinated integrated circuit chips. The processing circuitry 114A can implement multiple processor threads and/or multiple processor cores. The cache 114B is a memory that is located in the processor chip package(s) and is typically used for data or code that can be available for rapid access by the threads or cores running on the processor set 114. Cache memories are typically organized into multiple levels depending upon relative proximity to the processing circuitry 114A. Alternatively, some, or all, of the cache 114B for the processor set 114 can be located “off-chip.” In some computing environments, the processor set 114 can be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the various storage media discussed below. The program instructions, and associated data, are accessed by the processor set 114 to control and direct the performance of the disclosed methods. In computing environment 100, at least some of the instructions for performing the disclosed methods can be stored in the dynamic modification of the response validation module 120B in persistent storage 120.

The communication fabric 116 is the signal conduction path that allows the various components of computer 102 to communicate among themselves. Typically, this fabric is made of switches and electrically conductive paths, such as the switches and electrically conductive paths that make up buses, bridges, physical input/output ports, and the like. Various types of signal communication paths are used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by random access, but this is not utilized unless affirmatively indicated. In the computer 102, the volatile memory 118 is located in a single package and is internal to computer 102, but alternatively or additionally, the volatile memory 118 can be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 is a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A can take several forms, such as various known proprietary operating systems or open-source Portable Operating System Interface-type operating systems that employ a kernel. The code included in the response validation module 120B typically includes at least some of the computer code involved in performing the disclosed methods.

The peripheral device set 122 includes the set of peripheral devices of computer 102. Data communication connections between the peripheral devices and the various components of computer 102 can be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A includes components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B is persistent and/or volatile. In some embodiments of the disclosure, storage 122B takes the form of a quantum computing storage device for storing data in the form of qubits. In embodiments of the disclosure where computer 102 is utilized to have a large amount of storage (for example, where computer 102 locally stores and manages a large database) then this storage can be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, a first sensor can be a thermometer, and a second sensor can be a motion detector.

The network module 124 is the collection of computer software, hardware, and firmware that allows computer 102 to communicate with various computers through WAN 104. The network module 124 can include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN), the control functions and the forwarding functions of the network module 124 are performed on physically separate devices, such that the control functions manage several different network hardware devices. Computer-readable program instructions for performing the disclosed methods can typically be downloaded to computer 102 from an external computer or external storage device through a network adapter card or network interface included in the network module 124.

The WAN 104 is any wide area network (for example, the internet) for communicating computer data over non-local distances by any technology for communicating computer data, now known or to be developed in the future. In some embodiments of the disclosure, the WAN 104 can be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and can take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or present recommendations to an end user. In some embodiments of the disclosure, EUD 106 can be a client device, such as a thin client, heavy client, mainframe computer, desktop computer, and so on.

The remote server 108 is any computer system that serves at least some data and/or functionality to the computer 102. The remote server 108 can be controlled and used by the same entity that operates the computer 102. The remote server 108 represents the machine(s) that collect and store helpful and useful data for use by various computers, such as the computer 102. For example, in a hypothetical case where the computer 102 is designed and programmed to provide a recommendation based on historical data, then this historical data can be provided to the computer 102 from the remote database 108A of the remote server 108.

The public cloud 110 is any computer system available for use by multiple entities that provides on-demand availability of computer system resources and/or various computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs can be stored as images and can be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize the resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, a private cloud can be disconnected from the internet entirely and only accessible through a local/private network. A hybrid cloud is a composition of multiple clouds of different types (for example, private, community, or public cloud types), often respectively implemented by different vendors. Each cloud of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

Cloud computing services and/or microservices (not separately shown in FIG. 1A): private and public clouds are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, and laptops), through the Internet, to the provider's systems, and back. In some embodiments, cloud services can be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs (Application Programming Interfaces). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on-demand, and virtual private networks.

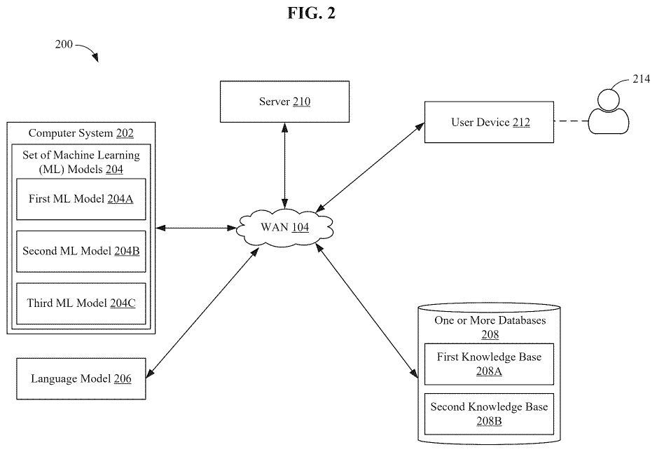

FIG. 2 is a diagram that illustrates a network environment for validation of domain-specific responses generated by a language model, in accordance with an embodiment of the disclosure. FIG. 2 is explained in conjunction with elements from FIG. 1. With reference to FIG. 2, there is shown a diagram of a network environment 200. The network environment 200 includes a system 202 (also referred to as the computer system 202), a set of machine learning (ML) models 204, a language model 206, one or more databases 208, a server 210, a user device 212, and a user 214. The system 202 includes a first machine learning (ML) model 204A, a second ML model 204B, and a third ML model 204C. The user device 212 is further associated with a user 214 interacting with the system 202. The network environment 200 further includes the WAN 104 of FIG. 1. In an embodiment of the disclosure, the user device 212 is an exemplary embodiment of the EUD 106. Similarly, the system 202 is an exemplary embodiment of the computer 102 in FIG. 1.

The system 202 includes suitable logic, circuitry, interfaces, and/or code to validate domain-specific responses generated by language models. The system 202 receives a response associated with a query. The response is generated by the language model 206. The response is associated with a specific domain (e.g., an information technology (IT) domain). The system 202 further generates a set of atomic responses associated with the response. The phrase “atomic response” refers to a subpart of the response. In other words, one response typically includes multiple subparts. In at least some embodiments, each of those atomic responses (i.e., subparts) includes at least one entity action pair. The entity action pair refers to an entity and an action associated with that entity. In other words, one ML response might include information about multiple entities and multiple actions. An atomic response refers to a subpart of the overall response. The single subpart includes at least one entity and at least one action associated with that entity. The system 202 further determines a set of entity action pairs associated with each atomic response of the set of atomic responses. Each entity action pair of the set of entity action pairs includes an entity and an action. The action is associated with the entity. The system 202 further determines a first validation score of a first set of validation scores associated with the response based on a presence of the set of entity action pairs within a first knowledge base 208A. The system 202 further determines a second validation score of the first set of validation scores associated with the response based on the set of atomic responses and the first knowledge base 208A. The system 202 further determines a second set of validation scores associated with the response based on a presence of the set of entity action pairs within a second knowledge base 208B. The system 202 further generates a final validation score associated with the response based on the first set of validation scores and the second set of validation scores. The system 202 further generates a first recommendation of one or more recommendations associated with the response based on the final validation score. The system 202 further controls an execution of a set of operations provided in the response based on the generated first recommendation.

Examples of the system 202 include, but are not limited to, a server, a computing device, a virtual computing device, a mainframe machine, a computer workstation, a smartphone, a cellular phone, a mobile phone, a gaming device, or a consumer electronic (CE) device. By way of example, and not by limitation, the system 202 is embodied as a cloud-based service, a cloud-based application, a cloud-based platform, a remote server-based service, a remote server-based application, a remote server-based platform, and/or a virtual computing system.

Each ML model of the set of ML models 204 is in various embodiments a computational network or a system of artificial neurons, arranged in a plurality of layers, as nodes. The plurality of layers of each ML model includes an input layer, one or more hidden layers, and an output layer. Each layer of the plurality of layers includes one or more nodes (or artificial neurons). Outputs of the nodes in the input layer are coupled to at least one node of the hidden layer(s). Similarly, inputs of each hidden layer are coupled to outputs of at least one node in subsequent layers of each ML model. Outputs of each hidden layer are coupled to inputs of at least one node in subsequent layers of each ML model. Node(s) in the final layer receive inputs from at least one hidden layer to output a result. The number of layers and the number of nodes in each layer are determined from the hyper-parameters of each ML model. Such hyper-parameters are set before or while training each ML model on a training dataset.

Each ML model of the set of ML models 204 includes a mathematical function (e.g., a sigmoid function or a rectified linear unit) with a set of parameters, tunable during the training of the network. The set of parameters include, for example, a weight parameter, a regularization parameter, and/or the like. Each node uses the mathematical function to compute an output based on one or more inputs from nodes in subsequent layer(s) (e.g., previous layer(s)) of each ML model. All or some of the nodes of each ML model of the set of ML models 204 correspond to the same or a different mathematical function.

During the training of each ML model of the set of ML models 204, one or more parameters of each node of each ML model are updated based on whether an output of the final layer for a given input (from the training dataset) matches a correct result based on a loss function for each ML model of the set of ML models 204. The above process is repeated for the same or a different input until a training error for a loss function is minimized. Several methods for training include, for example, gradient descent, stochastic gradient descent, batch gradient descent, gradient boost, meta-heuristics, and the like.

Each ML model of the set of ML models 204 includes electronic data, such as, for example, a software program, code of the software program, libraries, applications, scripts, logic, or instructions for execution by a processing device, such as the processor set 114. Each ML model of the set of ML models 204 includes code and routines configured to enable a computing device, such as the system 202, to perform one or more operations. Additionally, each ML model is implemented using hardware including a processor, a microprocessor (e.g., to perform or control the performance of one or more operations), a field-programmable gate array (FPGA), or an application-specific integrated circuit (ASIC). Alternatively, in some embodiments, each ML model of the set of ML models 204 is implemented using a combination of hardware and software. In FIG. 2, each ML model of the set of ML models 204 is integrated within the system 202, but the disclosure is not so limited. Accordingly, in some embodiments, each ML model of the set of ML models 204 is stored in another computer or server outside the system 202, without deviation from the scope of the disclosure. In an embodiment, each ML model is stored in the server 210. Examples of each ML model include but are not limited to, a deep neural network (DNN), a convolutional neural network (CNN), a CNN-recurrent neural network (CNN-RNN), an artificial neural network (ANN), a fully connected neural network, and/or a combination of such networks.

In various embodiments, the language model 206 is a sophisticated piece of software that leverages natural language processing (NLP) and machine learning processes to understand, generate, and manipulate human language. For example, the language model 206 is a large language model (LLM) that is specifically designed for tasks related to language understanding and generation on a large scale. Some characteristics of the language model 206 include but are not limited to, natural language understanding, text generation, semantic understanding, transfer learning, multimodal capabilities, continuous learning, and user interaction. By way of an example, and not by limitation, the language model 206 for language processing is implemented using GPT, Bidirectional Encoder Representations from Transformers (BERT), and the like.

The language model 206 is any machine learning model configured to generate responses based on input queries. In an embodiment, the language model 206 operates using natural language processing (NLP) processes and architectures such as neural networks, particularly transformer-based machine learning models. In an embodiment, the language model 206 generates a set of responses to the input in a specific domain by utilizing pre-trained knowledge gained from using large domain-specific datasets as training data, through fine-tuning or real-time processing.

Further, the language model 206 is a type of ML model specifically designed to understand, generate, and manipulate human language on a large scale. Language models (LMs) can leverage machine learning processes, particularly those based on deep learning architectures, to process and comprehend natural language. LMs have gained prominence for their ability to perform a wide range of language-related tasks, including natural language understanding, text generation, translation, summarization, and more. Typically, LMs are characterized by a vast number of parameters, often ranging from tens of millions to billions. The large parameter count allows these models to capture complex language patterns and relationships during training.

Each database of the one or more databases 208 in various embodiments is an organized collection of data that is stored in computer memory storage and accessed electronically from a computer system (such as the system 202). In an embodiment, each database of the one or more databases 208 stores the response. In an embodiment, the one or more databases 208 stores the query and the set of atomic responses. The one or more databases 208 are designed to manage, store, retrieve, and update the user data efficiently. The structure of the one or more databases 208 typically involves tables, records, and fields that can be managed through various database management systems (DBMS). Examples of the one or more databases 208 include, but are not limited to, a relational database, a Non-Structured Query Language (NoSQL) database, a hierarchical database, a network database, a transactional database, a data warehouse, a distributed database, or the like.

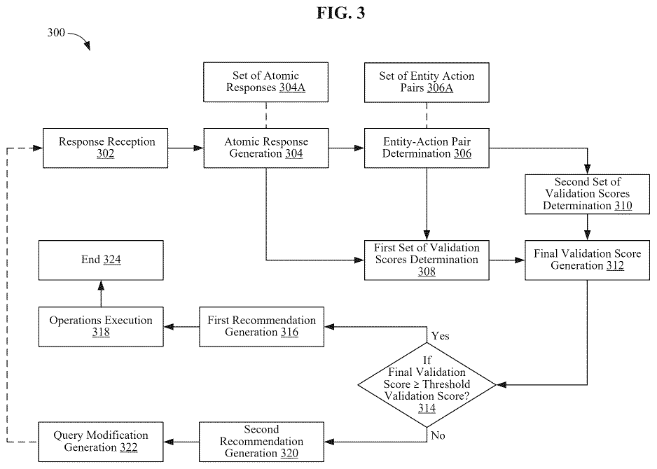

In an embodiment, the one or more databases 208 stores a first knowledge base 208A and a second knowledge base 208B. The first knowledge base 208A includes in at least some embodiments a source document that includes information associated with a specific domain (or a product or service within the specific domain). The source document serves as a reference for validating the response generated by the language model 206. The source document further includes one or more technical manuals, system logs, knowledge bases, regulatory documents, research papers, and historical records associated with the specific domain. In at least some embodiments, the second knowledge base 208B is or includes an ontology map including entity and action links associated with the specific domain. The ontology map is utilized to generate a validation score associated with the entity and actions associated with the response generated by the language model 206. Details about the first knowledge base 208A and the second knowledge base 208B are provided, for example, in FIG. 3.

The server 210 includes suitable logic, circuitry, interfaces, and/or code to store the response, the set of atomic responses, and the set of entity action pairs. The server 210 includes data storage to store the first set of validation scores, and the second set of validation scores. In some embodiments, the server 210 stores the final validation score and the set of actions in data storage. In some embodiments, the server 210 stores the and the one or more recommendations. The server 210 can be implemented as a cloud server and can execute operations through web applications, cloud applications, HTTP requests, repository operations, file transfer, and the like. Additional example implementations of the server 210 include but are not limited to, a database server, a file server, a web server, a media server, an application server, a mainframe server, or a cloud computing server.

In at least one embodiment, the server 210 is implemented as a plurality of distributed cloud-based resources by use of several technologies. The scope of the disclosure is not limited to the implementation of the server 210 and the system 202 as two separate entities. In certain embodiments, the functionalities of the server 210 are incorporated in their entirety or at least partially in the system 202, without a departure from the scope of the disclosure.

The server 210 is any computer system that serves at least some data and/or functionality to the computer 102. The server 210 can be controlled and used by the same entity that operates the computer 102. The server 210 represents the computer(s) that collect and store helpful and useful data for use by various computers, such as the computer 102. For example, in a hypothetical case where the computer 102 is designed and programmed to provide a recommendation based on historical data, then this historical data can be provided to the computer 102 from at least one of the databases 208 of the server 210. Thus, although FIG. 2 shows the one or more databases 208 as being external to the server 210, in some embodiments, the one or more databases 208 are stored within the server 210.

The user device 212 includes suitable logic, circuitry, and/or interfaces that are configured to execute one or more tasks within the network environment 200. The system 202 utilizes the user device 212 to perform one or more tasks such as receiving response data, processing the response data, and transmitting the response data. In an embodiment of the disclosure, the system 202 renders the one or more recommendations associated with the response generated by the language model 206 on the user device 212. By way of example, and not by limitation, the user device 212 corresponds to a smartphone, a cellular phone, a mobile phone, a consumer electronic (CE) device, an Internet of Things (IoT) device, a computing device, a mainframe machine, a server, a computer workstation, or the like. In some instances, the response validation module 120B generates a user interface, e.g., a graphical user interface, that is presented via the user device 212 to present information and to receive feedback from the user 214. For example, feedback is received via the user 214 using an input device connected to the user device 212 to interact with the user interface that is presented.

In operation, the system 202 receives a response generated by the language model 206. The response is generated for the query associated with the specific domain (e.g., the information technology (IT) domain). In other words, the query is input into the language model 206, and, in response, the language model 206 analyzes the query, generates a response to the query based on the analysis, and outputs the response. The response includes a set of operations to be performed by the system 202. However, the user 214 may wish to validate the response before performing the set of operations. To validate the response, the system 202, e.g., the response validation module 120B of the system 202, generates the set of atomic responses associated with the response. This generation in various embodiments includes breaking down the response into subparts. For example, in at least some embodiments each subpart includes an entity associated with the specific domain and an action associated with the entity. In an embodiment, the system 202 applies the first ML model 204A to the response. In other words, the response is input into the first ML model 204A, and, in response, the first ML model 204A analyzes the response, generates atomic responses based on the analysis, and outputs the atomic responses. Based on the application of the first ML model 204A to the response, the system 202 generates the set of atomic responses. In an embodiment, each atomic response of the set of responses includes an entity and an action associated with the entity. In at least some embodiments, the system 202 feeds all or some of the atomic responses that are generated into the second ML model 204B. In other words, the atomic responses are input into the second ML model 204B, and, in response, the second ML model 204B analyzes the atomic responses, identifies entity action pairs that are within the atomic responses, and outputs a list of the identified entity action pairs. Based on the application of the second ML model 204B to the atomic responses, the system 202 determines the set of entity action pairs. The system 202 further applies the third ML model 204C to the entity action pair and the first knowledge base 208A of the one or more databases 208. Based on the application of the third ML model 204C the system 202 determines the first validation score of the first set of validation scores. In at least some embodiments, the system 202 applies the third ML model 204C to each atomic response of the set of atomic responses and the first knowledge base 208A.

Based on the application of the third ML model 204C to the set of atomic responses and the first knowledge base 208A, the system 202 determines the second validation score of the first set of validation scores. The system 202 applies the third ML model 204C to the set of entity action pairs and the second knowledge base 208B. Based on the application of the third ML model 204C to the set of entity action pairs and the second knowledge base 208B, the system 202 determines the second set of validation scores. The system 202 generates the final validation score based on the first set of validation scores and the second set of validation scores. The system 202 compares the final validation score with the threshold validation score. Based on the comparison, the system 202 generates one or more recommendations associated with the response generated by the language model. The system 202 controls an execution the one or more recommendations associated with the response generated by the language model 206 based on the generated recommendation.

FIG. 3 is a diagram that illustrates the first exemplary operations for validation of domain-specific responses generated by the language model, in accordance with an embodiment of the disclosure. FIG. 3 is explained in conjunction with elements from FIG. 1 and FIG. 2. With reference to FIG. 3, there is shown the block diagram 300 that illustrates exemplary operations from 302 to 324, as described herein. The exemplary operations illustrated in the block diagram 300 start at 302 and are performed by any computing system, apparatus, or device, such as by the computer 102 of FIG. 1 (and specifically the response validation module 120B) or by the system 202 of FIG. 2. Although illustrated with discrete blocks, the exemplary operations associated with one or more blocks of the block diagram 300 can be divided into additional blocks, combined into fewer blocks, or eliminated, depending on the implementation.

In an embodiment, the user 214 encounters a problem within a specific domain (such as an IT domain) that the user 214 wishes to solve. To resolve the query, the user 214 provides the problem, as a query, that is input to the language model 206. The language model 206, in response, generates a response that includes a set of actions suggested by the language model 206 to resolve the query. However, the user 214 wishes to validate the generated response before actually performing the set of operations. To validate the generated response, the user 214 utilizes the system 202 (e.g., the response validation module 120B) to perform the below-mentioned operations.

At 302, a response reception operation is executed. In the response reception operation, the system 202 receives a response generated by the language model 206. Specifically, as the query is associated with a specific domain, the response that is generated for the query is also associated with the specific domain. In an embodiment, the system 202 receives the response from the language model 206 or the user device 212.

In an embodiment, the response includes a set of operations to be performed on the system 202 to resolve the query or the problem indicated in the query. By way of example, and not by limitation, the query corresponds to one or more of an operational task such as troubleshooting a database, minimizing the risk of system failure, improving system performance, and scaling system resources associated with the IT domain.

The system 202 receives the response generated by the language model 206. As a first example, the response associated with the query “What are the steps to configure a virtual machine for secure access”, includes “To configure a virtual machine (VM) for secure access, update the firewall rules to allow only SSH on port 22, set up multi-factor authentication for the VM, and configure the security groups to restrict inbound traffic to defined IP ranges”.

At 304, an atomic response generation operation is executed. In the atomic response generation operation, the system 202 generates a set of atomic responses 304A associated with the response. In an embodiment, the system 202 applies the first ML model 204A to the response generated by the language model 206. Based on the application of the first ML model 204A, the system 202 generates the set of atomic responses 304A associated with the response. The set of atomic responses 304A corresponds to one or more segments of the response and includes an entity and an action associated with the entity. In an embodiment, each atomic response of the set of atomic responses 304A represents a unit of response, in the form of an entity-action pair. The unit of response (i.e., subpart) represents an individual unit of the response generated by the language model 206.

In an embodiment, the entity refers to a distinct object or component that has a unique identity and attributes. Such entities can be characterized by their properties, which define their attributes and behaviors. In the IT domain, the entity corresponds to one or more of hardware components, software modules, virtual resources, and configuration parameters. By way of example, and not by limitation, in the IT domain, the entities include but are not limited to, one or more of virtual machines, firewalls, load balancers, database instances, Kubernetes pods, and configuration files.

In an embodiment, the actions associated with the entity correspond to a task or operation performed on or by the entity. The actions include, but are not limited to one or more of management configuration, monitoring, and troubleshooting tasks. The entities associated with the atomic response “Update the firewall rules to allow only SSH on port 22” include “Firewall rules” and the action associated with the entity includes “Update”. Specifically, the actions define how entities interact among themselves and with the system itself.

In an alternate embodiment, the system 202 further leverages transformer-based architectures, such as BERT, GPT, or a rule-based NLP parser to analyze the structure of the received response. Based on the analysis of the structure of the received response, the system 202 generates the set of atomic responses 304A. The decomposition process involves segmenting the response into the set of atomic responses 304A including the entity action pairs. In an embodiment, the set of atomic responses 304A represents individual units of the response generated by the language model 206 in the specific domain.

With reference to the first example, the system 202 e.g., the response validation module 120B, is configured to segment the response “To configure a virtual machine (VM) for secure access, update the firewall rules to allow only SSH on port 22, set up multi-factor authentication for the VM, and configure the security groups to restrict inbound traffic to trusted IP ranges” into the set of atomic responses 304A. The set of atomic responses 304A includes a first atomic response that may be “Update the firewall rules”, a second atomic response that may be “set up Confident 25 multi-factor authentication”, and a third atomic response that may be “Configure the security groups”. The system 202 further ensures that each atomic response of the set of atomic responses 304A includes the entity and the action.

At 306, an entity-action pair determination operation is executed. In the entity-action pair determination operation, the system 202 determines the entity-action pair from the set of atomic responses 304A. Each entity action pair of the set of entity action pairs 306A includes the entity and the action associated with the entity. In an embodiment, the system 202 extracts the entity and the action associated with each atomic response of the set of atomic responses 304A to determine the entity-action pair. In an embodiment, the system 202 applies the second ML model 204B on each atomic response of the set of atomic responses 304A to extract the entity and the action associated with the entity from each atomic response of the set of atomic responses 304A. In an alternate embodiment, the system 202 extracts the entity and the actions from the set of atomic responses 304A using processes such as, but not limited to, one or more of named entity recognition (NER), relation extraction, and regular expressions.

With reference to the first example, for the first atomic response “Update the firewall rules”, the entity may be “Firewall Rules” and the action may be “Update”. For the second atomic response “Set up multi-factor authentication”, the entity may be “multi-factor authentication” and the action may be “Set up”. Similarly, for the third atomic response “Configure the security groups”, the entity may be “Security Groups” and the action may be “Configure”. The response validation module 120B, e.g., the second machine learning model 204B performs these identifications/extractions.

At 308, a first set of validation scores are determined. In this step, the system 202 determines a first validation score and a second validation score for the response. The first validation score and the second validation score together form a first set of validation scores. The system 202 determines the first validation score based on whether the set of entity action pairs 306A are present within the first knowledge base 208A. In an embodiment, the first knowledge base 208A includes a source document that is associated with the specific domain. One example of the source document is an original record that contains the details supporting or substantiating a transaction, which can be entered into an accounting or information system.

By way of example and not by limitation, the source document associated with the IT domain refers to an original record that captures data or transactions before they are entered into an information system, serving as a foundational reference for data integrity and processing. The source document includes various forms such as one or more of system logs, user input forms, transaction records, configuration files, and change requests. The source document is vital for maintaining accuracy, supporting audits, and ensuring compliance with regulatory standards, as they provide reliable proof of transactions and events. By offering a historical context for the system changes and facilitating troubleshooting, the source documents play a vital role in effective data management practices within IT environments. In an embodiment, the source document includes a user guide associated with a product or a service within the specific domain.

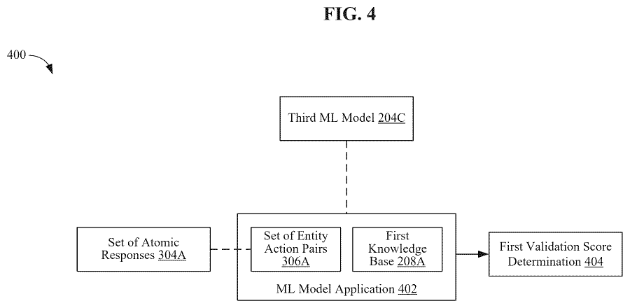

To determine the first validation score of the first set of validation scores, the system 202 extracts the entity and the action associated with the entity in each atomic response of the set of atomic responses. Further, the system 202 determines whether the entity and the action associated with the entity in each atomic response are in the first knowledge base 208A. Based on the determined presence of the extracted entity and action associated with the entity in the first knowledge base 208A, the system 202 determines the first validation score of the first set of validation scores. In an embodiment, the system 202 determines the presence of the set of entity action pairs 306A in the first knowledge base 208A using one or more of natural language processing (NLP) processes, similarity measures, clustering processes, contextual analysis, and the like. Some examples of details about the determination of the first validation score of the first set of validation scores are provided in FIG. 4.

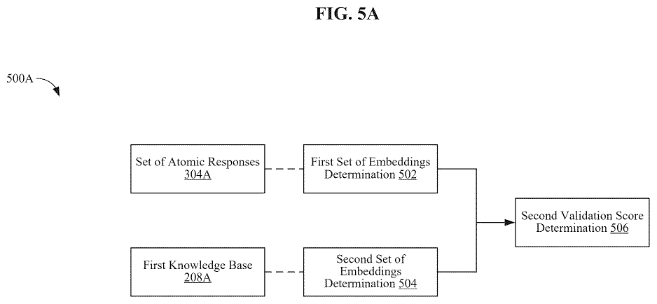

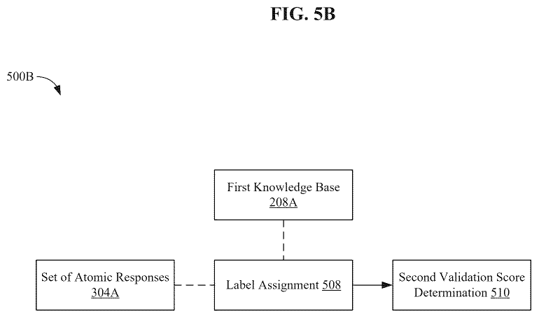

The system 202 determines a second validation score based on the set of atomic responses and the first knowledge base 208A. Specifically, the system 202 determines the second validation score based on whether the set of atomic responses is present within the first knowledge base 208A. In an embodiment, the system 202 utilizes processes such as similarity scores, similarity measures, clustering processes, contextual analysis, and the like. Some exemplary details about the determination of the second validation score of the first set of validation scores are provided in FIG. 5A and FIG. 5B.

It is to be noted that in some embodiments the first validation score of the first set of validation scores is determined based on the presence of the set of entity action pairs 306A within the first knowledge base 208A whereas the second validation score of the first set of validation scores is determined based on the presence or absence of the set of atomic responses 304A within the first knowledge base 208A. Therefore, the first validation score of the first set of validation scores can also be referred to as the action-entity evidence validation score or entity and action existence validation score, and the second validation score of the first set of validation scores can also be referred to as atomic response evidence validation score or claim existence validation score.

At 310, a second set of validation scores are determined. In this step, the system 202 determines the second set of validation scores associated with the response. In the determination of the second set of validation scores, the system 202 utilizes extracted entities and actions associated with the entities, and the second knowledge base 208B. As discussed above, in at least some embodiments the second knowledge base 208B includes an ontology map associated with the specific domain.

In an embodiment, the ontology map is a structured framework that defines the relationships between various entities and actions within the specific domain. The ontology map serves as a semantic representation that links data to meaningful concepts, allowing for better understanding and integration of information. Specifically, the ontology map outlines how different entities—such as objects, actions, and their properties—interact amongst themselves, providing a comprehensive view of the structure of the specific domain.

By way of example, the ontology map in the IT domain corresponds to a structured representation that defines the relationships between various entities (such as data types, processes, and systems) and actions (like data processing, retrieval, and storage). This map serves as a formal specification of knowledge within a specific domain, facilitating interoperability and semantic understanding among disparate systems. By employing classes, properties, and relationships, the ontology map allows for the visualization of how entities interact and the actions that can be performed on them. This interconnected framework enhances data integration, supports automated reasoning, and improves knowledge management by making explicit the underlying concepts and their interrelations within IT systems.

In an embodiment, the system 202 determines the second set of validation scores associated with the response based on whether the set of entity action pairs 306A are present within the second knowledge base 208B. By way of one example, in case the set of entity action pairs 306A is present within the second knowledge base 208B, the first validation score of the second set of validation scores is “50”. Otherwise, the first validation score of the second set of validation scores is “0”.

In an embodiment, the system 202 employs several processes like rule-based approaches that define specific semantic rules, pattern-based methods identifying structural patterns, and/or graph-based processes utilizing graph algorithms for traversal and community detection. In an embodiment, the system 202 uses one or more machine learning models that were trained on labeled datasets to learn and predict relationships, while semantic reasoning processes like description logics are utilized to infer links based on axioms.

At 312, a final validation score is generated. In this step, the system 202 utilizes the first set of validation scores and the second set of validation scores to generate the final validation score. In an embodiment, the system 202 employs ensemble processes or weighted averaging to combine the first set of validation scores and the second set of validation scores. By way of example, and not by limitation, if the average of the first set of validation scores is 88 and the second set of validation scores is 92, then the system calculates the final validation score as 90 based on the combination (e.g. weighted average method if the weights assigned to the first set of validation scores and the second set of validation scores are same).

In an embodiment, the system 202 aggregates the first set of validation scores and the second set of validation scores to generate the final validation score. In an embodiment, the system 202 utilizes a weighted aggregation formula to generate the final validation score. By way of example, and not by limitation, the weighted aggregation formula combines the first set of validation scores and the first set of validation scores along with a weighted value assigned to each validation score. In an embodiment, the system 202 determines the final validation score using the weighted aggregation formula provided in equation (1) as follows:

$$F V S = {w}_{1} \cdot {v}_{1} + {w}_{2} \cdot {v}_{2} + {w}_{3} \cdot {v}_{3} \qquad ( 1 )$$

where,
FVS corresponds to the final validation score,
w₁ corresponds to a first weighed value associated with the first validation score of the first set of validation scores,
w₂ corresponds to a second weighed value associated with the second validation score of the first set of validation scores,
w₃ corresponds to a third weighed value associated with the second set of validation scores,
v₁ corresponds to the first validation score of the first set of validation scores,
v₂ corresponds to the second validation score of the first set of validation scores, and
v₃ corresponds to the second set of validation scores.

In an embodiment, the system 202 generates a final validation score for the response generated by the language model 206. The final validation score corresponds to an aggregate measure of the accuracy and relevance of the response generated by the language model 206 in the domain-specific environment. Further, the final validation score represents the measure of trustworthiness of the response generated by the language model 206 for the query. In at least some embodiments, the calculated final validation score is further compared to a threshold validation score to generate one or more recommendations associated with the response as described above.

At 314, it is determined whether the final validation score is greater than or equal to a threshold validation score. The threshold validation score is a defined validation score that acts as a reference to determine whether the response generated by the language model 206 is considered acceptable (accurate) or not. In case the final validation score is greater than or equal to the threshold validation score, the control is transferred to step 316. Otherwise, the control is transferred to step 320.

At 316, a first recommendation is generated. In this step, the system 202 generates the first recommendation in response to the final validation score being greater than or equal to the threshold validation score. Further, the first recommendation is indicative of the execution of the set of operations provided in the response. For example, based on the final validation score being greater than or equal to the threshold validation score, the system 202 displays on the user device 212 the first recommendation: “The recommendation associated with the response generated by language model can be executed on the system” and/or controls the execution of the set of operations.

At 318, an operation is executed. In this step, the system 202 controls an execution of a set of operations based on the generated first recommendation. In at least some embodiments, the generated first recommendation was part of the response initially output by the generative machine learning model, e.g., the language model 206. With reference to the first example, the system 202 controls the execution of one or more of the operations such as “updating the firewall rules to allow only SSH on port 22”, “setting up multi-factor authentication for the VM”, and “configuring the security groups to restrict inbound traffic to defined IP ranges” to “configure a virtual machine (VM) for secure access”. In an embodiment, the system 202 controls the execution of the set of operations on the user device 212. In an alternate embodiment, the system 202 controls the execution of the set of operations on the system 202 itself.

At 320, a second recommendation is generated. In this step, the system 202 generates the second recommendation in response to the final validation score being less than the threshold validation score. Further, the second recommendation is indicative of a modification to be performed in the query. For example, based on the final validation score being less than the threshold validation score, the system 202 displays on the user device 212 the recommendation “The recommendation associated with the response generated by language model cannot be executed on the system. Please refine the query”.

At 322, a query modification operation is executed. In the query modification operation, the system 202 modifies the query. In an embodiment, the system 202 modifies the query based on the generated second recommendation. In an embodiment, the modification of the query includes a refinement of the query to add more contextual information within the query. The modified query can be again provided, as input, to the language model 206. The language model 206 outputs the first set of operations in response to receiving and analyzing the modified query. The operations may be repeated until the process ends at 324.

FIG. 4 is a diagram that illustrates exemplary operations for the determination of the first validation score of the first set of validation scores, in accordance with an embodiment of the disclosure. FIG. 4 is explained in conjunction with elements from FIG. 1, FIG. 2, and FIG. 3. With reference to FIG. 4, the block diagram 400 illustrates exemplary operation from 402 to 404 for the determination of the first validation score. The exemplary operations illustrated in the block diagram 400 start at 402 and are performed by any computing system, apparatus, or device, such as by the computer 102 and the response validation module 120B of FIG. 1 or by the system 202 of FIG. 2. Although illustrated with discrete blocks, the exemplary operations associated with one or more blocks of the block diagram 400 can be divided into additional blocks, combined into fewer blocks, or eliminated, depending on the implementation.

At 402, a ML model is executed. In this step, the system 202 applies the third ML model 204C to the set of entity action pairs 306A and the first knowledge base 208A. In an embodiment, the third ML model 204C is a trained ML model that was trained to perform a similarity search between the set of entity action pairs 306A and the first knowledge base 208A. The similarity search leverages mathematical and statistical processes to evaluate the degree of similarity between the set of entity action pairs 306A and the first knowledge base 208A, allowing the system 202 to identify relevant items that share characteristics with the query. For example, the similarity search incorporates keyword searching and/or embedding generation and comparison (using cosine similarity, Euclidean distance, Manhattan distance, Chebyshev distance, etc.)

In an embodiment, the system 202 determines the set of entity action pairs 306A associated with the set of atomic responses 304A based on the application of the second ML model 204B to the set of atomic responses 304A. In other words, the set of atomic responses 304A is input into the second ML model 204B and, in response, the second ML model 204B determines or identifies the set of entity action pairs 306A. Each entity action pair of the set of entity action pairs 306A includes the entity and the action associated with the entity. In some instances, the system 202 retrieves the first knowledge base 208A from the one or more databases 208, e.g., from an external server or a data storage area of the same server/computer hosting the response validation module 120B. In some instances, the retrieval of the first knowledge base 208A is based on a domain associated with the query and the response for/from the ML model. For example, the data storage stores multiple knowledge bases, e.g., multiple source documents. The ML model performs semantic analysis with embedding comparison, keyword analysis, etc. to identify a knowledge base of the multiple knowledge bases that is the best match for the query and its domain. The best matching knowledge base is retrieved for use as the first knowledge base in the method.

Further, in some embodiments, the system 202 applies the third ML model 204C to the determined set of atomic responses 304A and the first knowledge base 208A. In an embodiment, the third ML model 204C performs the similarity search operation between the set of atomic responses and the first knowledge base 208A to determine whether the entities and the actions are present within the first knowledge base 208A.

At 404, a first validation score is determined in some embodiments. In this step, the system 202 determines the first validation score based on the output generated by the third ML model 204C that analyzed the set of entity action pairs 306A and the first knowledge base 208A. In an embodiment, the first validation score of the set of validation scores includes a confidence score produced by the third ML model 204C. In case the set of entity action pairs 306A is present in the first knowledge base 208A, the first validation score is greater than the first threshold score. Otherwise, if the set of entity action pairs 306A is absent in the first knowledge base 208A, the first validation score is less than the first threshold score in some embodiments.

FIG. 5A is a diagram that illustrates an exemplary first set of operations for the determination of the second validation score of the first set of validation scores, in accordance with an embodiment of the disclosure. FIG. 5A is explained in conjunction with elements from FIG. 1, FIG. 2, FIG. 3, and FIG. 4. With reference to FIG. 5A, the block diagram 500A illustrates exemplary operations from 502 to 506, as described herein. The exemplary operations illustrated in the block diagram 500A start at 502 and are performed by any computing system, apparatus, or device, such as by the computer 102 and the response validation module 120B of FIG. 1 or by the system 202 of FIG. 2. With reference to FIG. 5A, the exemplary operations associated with one or more blocks of the block diagram 500A can be divided into additional blocks, combined into fewer blocks, or eliminated, depending on the implementation.

At 502, a first set of embeddings is generated. In this step, the system 202 generates a set of embeddings associated with the set of atomic responses 304A, e.g., generates a respective embedding for each atomic response of the set of atomic responses 304A. Embeddings are a numerical representation of an object, such as a word, image, entity, or atomic response. In an embodiment, the embedding corresponds to a vector representation of a corresponding atomic response of the set of atomic responses 304A. In an embodiment, the system 202 applies one or more neural network models on the set of atomic responses 304A to generate the first set of embeddings associated with the set of atomic responses 304A. For example, an embedding layer or encoder portion of a neural network is used to generate the embeddings.

At 504, a second set of embeddings is generated. In this step, the system 202 generates a set of embeddings representing the first knowledge base 208A. As discussed above, the embedding is a numerical representation of the first knowledge base 208A which can be the source document. In an embodiment, the system 202 applies the one or more neural network models on the text of the first knowledge base 208A to generate the set of embedding representing the first knowledge base 208A. For example, an embedding layer or encoder portion of a neural network is used to generate the embeddings. These embeddings generated in step 504 are input into the same embedding space in which the embeddings were generated in step 502, to facilitate a comparison of the two sets of embeddings.

At 506, a second validation score is determined. In this step, the system 202 determines the second validation score of the first set of validation scores, e.g., by comparing the first set of embeddings 502 representing the set of atomic responses 304A and the second set of embeddings 504 representing the first knowledge base 208A. In an embodiment, the second validation score is or includes a similarity score between the two sets of embeddings that represent the set of atomic responses 304A and the first knowledge base 208A. The similarity score indicates a similarity between the set of atomic responses 304A and the first knowledge base 208A. In an embodiment, the system 202 determines one or more of a Euclidean distance, a cosine similarity, a Manhattan distance, and a Chebyshev distance between the two sets of embeddings to perform this step 506. The determined distance/similarity represents the second validation score of the first set of validation scores. In an embodiment, the second validation score is referred to as an atomic response existence validation score. The atomic response existence validation score further corresponds to the existence of each atomic response of the set of atomic responses 304A within the first knowledge base 208A.

FIG. 5B is a diagram that illustrates an exemplary second set of operations for the determination of the second validation score of the first set of validation scores, in accordance with an embodiment of the disclosure. FIG. 5B is explained in conjunction with elements from FIG. 1, FIG. 2, FIG. 3, FIG. 4 and FIG. 5A. With reference to FIG. 5B, the block diagram 500B illustrates exemplary operations from 508 to 510, as described herein. The exemplary operations illustrated in the block diagram 500B start at 508 and are performed by any computing system, apparatus, or device, such as by the computer 102 of FIG. 1 or by the system 202 of FIG. 2. With reference to FIG. 5B, the exemplary operations associated with one or more blocks of the block diagram 500B can be divided into additional blocks, combined into fewer blocks, or eliminated, depending on the implementation.

At 508, labels are assigned. In this step, the system 202 assigns a first label or a second label to each atomic response of the set of atomic responses 304A based on whether the first knowledge base 208A included same. Specifically, the system 202 assigns a binary label (e.g., True or False) to each atomic response of the set of atomic responses 304A based on a validation of the corresponding atomic response against the first knowledge base 208A. The validation of the corresponding atomic response against the first knowledge base 208A involves checking whether the atomic response (or the information in the atomic response) can be found in the first knowledge base 208A, is not found in the first knowledge base 208A, or if the atomic response contradicts information in the first knowledge base 208A. In case the atomic response (or the information in the atomic response) is found in the first knowledge base 208A, then the system 202 assigns a first binary label (e.g. True) to the corresponding atomic response. Otherwise, the system 202 assigns a second binary label (e.g. False) to the corresponding atomic response. Thus, with this labelling the evidence validation has a Boolean metric type.

At 510, a second validation score is determined. In this step, the system 202 determines the second validation score of the first set of validation scores based on the label assignment operation. In an embodiment, the system 202 determines the second validation score of the first set of validation scores based on the assignment of the one of the first label or the second label to each atomic response of the set of atomic responses 304A. In an embodiment, the second validation score is the percentage of atomic responses that are labeled as true from a total number of atomic responses in the set of atomic responses 304A. This score provides a metric for evaluating the overall factual accuracy of the generated response. By way of example, and not by limitation, if the total number of atomic responses in the set of atomic responses 304A is 5, and the system 202 assigns the “True” label to four atomic responses and the “False” label to one atomic response, then the percentage of atomic responses that labeled as true from a total number of atomic responses in the set of atomic responses 304A is 80% and thereby, the second validation score is 80. Thus, the score is determined using a fraction of valid components divided by a total number of components.

In various embodiments, the system 202 utilizes an Automatic Attribution Inference System (AutoAIS) for the determination of the second validation score of the first set of validation scores. The AutoAIS is a framework designed to evaluate the attribution capabilities of language models (such as the language model 206A), particularly in the context of question-answering tasks. The AutoAIS aims to automate the evaluation of how well the language model attributes its responses to the correct sources (such as the first knowledge base 208A). The AutoAIS uses various evaluation metrics including NLI Score (Natural Language Inference Score). The NLI score indicates a degree of entailment between the generated atomic response and the source document. The system 202 further utilizes an AutoAIS decision that is a binary decision (Y/N) indicating whether the model considers a claim attributable based on the NLI score threshold (e.g., greater than 0.5).

In an embodiment, the AutoAIS is integrated with a transformer-based machine learning model that is fine-tuned for diverse tasks. AutoAIS enhances the ability of the system 202 to generate relevant and accurately attributed responses. This integration facilitates automatic evaluation by allowing the processing of input data questions and answers and assessing their alignment with the corresponding knowledge base. The system 202 further determines the first validation score.

In an alternate embodiment, the system 202 uses one or more language machine learning models for the determination of the second validation score of the first set of validation scores. In an embodiment, the system 202 employs one or more prompt refinement processes to refine the prompt and determine the second validation score based on the modified prompt. In such a case, in some instances the one or more language models produce a confidence score as part of the output it produces in response to receiving the modified prompt. In some instances, the second validation score is or corresponds to this confidence score. The confidence score indicates a confidence (quantified by a numerical value) that the output is correct.

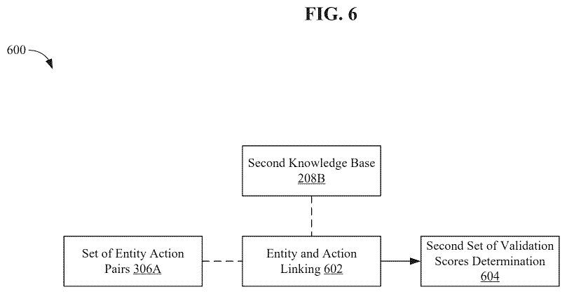

FIG. 6 is a diagram that illustrates exemplary operations for the determination of the second set of validation scores, in accordance with an embodiment of the disclosure. FIG. 6 is explained in conjunction with elements from FIG. 1, FIG. 2, FIG. 3, FIG. 4, FIG. 5A, and FIG. 5B. With reference to FIG. 6, the block diagram 600 illustrates exemplary operation from 602 to 604, as described herein. The exemplary operations illustrated in the block diagram 600 start at 602 and are performed by any computing system, apparatus, or device, such as by the computer 102 of FIG. 1 or by the system 202 of FIG. 2. With reference to FIG. 6, the exemplary operations associated with one or more blocks of the block diagram 600 can be divided into additional blocks, combined into fewer blocks, or eliminated, depending on the implementation.

At 602, an entity-action link is validated. In this step, the system 202 utilizes the second ML model 204B to perform a validation of the set of entity action pairs 306A associated with each atomic response with the second knowledge base 208B. In an embodiment, the system 202 retrieves the second knowledge base 208B (e.g., an IT ontology map), which can be or include a structured repository of the entity action links associated with the specific domain (e.g. IT domain). In an embodiment, the system utilizes the second ML model 204B to validate the entity-action link based on the comparison of the corresponding entity-action pair within the second knowledge base 208B. The validation of the entity-action link corresponds to the presence of the entity-action link in the second knowledge base 208B. In some embodiments, the second knowledge base 208B is retrieved from an external server or from a data storage area of the same server/computer hosting the response validation module 120B. In some instances, the retrieval of the second knowledge base 208B is based on a domain associated with the query and the response for/from the ML model. For example, the data storage stores multiple knowledge bases, e.g., multiple ontology maps. The ML model performs semantic analysis with embedding comparison, keyword analysis, etc. to identify a knowledge base of the multiple knowledge bases that is a best match for the query and its domain. The best matching knowledge base is retrieved for use as the second knowledge base in the method.

By way of example, and not by limitation, the system 202 validates the entity action link such as “Database instance-Restart” by first identifying the link “Database instance-Restart, or Restart-Database instance” within the second knowledge base 208B (IT ontology map). Based on the presence of the extracted entity action pair within the second knowledge base 208B, the system 202 assigns a validation score associated with each entity action pair. For example, if the presence is validated then the score is “50” and if the presence is not validated then the score is “0”.

At 604, a second set of validation scores are determined. In this step, the system 202 determines the second set of validation scores based on whether or not the entity action pair is present within the second knowledge base 208B. In an embodiment, the first validation score of the second set of validation scores is or includes a confidence score of a ML model that is utilized by the system 202 to determine the presence of the entity action pair within the second knowledge base 208B. In an alternate embodiment, the second set of validation scores is determined based on the confidence score of the ML model. In case the set of entity action pairs 306A is present in the second knowledge base 208B, the second set of validation scores is in some embodiments greater than a second threshold value. Otherwise, if the set of entity action pairs 306A is absent in the second knowledge base 208B, then the first validation score is less than the second threshold value.

By way of example, and not by limitation, for the atomic response “The router may be reformatted to enhance network performance”, the system 202 extracts the entity as “router” and the action as “reformat”. Further, the system 202 determines the presence of a “router-reformat” entity-action pair in the second knowledge base 208B and based on the presence of the valid link of the entity-action pair in the second knowledge base 208B, the system 202 assigns a high validation score, e.g., a validation score that is higher than the second threshold value.

In various embodiments, the scores determined herein are fraction metric types that are determined by dividing a number of valid components (e.g., entity-action pair, atomic response, etc.) compared to a total number of the components.

In some embodiments, the response validation module 120B generates explanations to improve explainability of the process. For example, after the atomic responses are produced via decomposing the ML model output, an individual atomic response is input into a generative ML model with a prompt that instructs the ML model to provide an explanation about how the decomposition occurs and why a particular atomic response was selected to be an atomic response. This prompt is in various embodiments a chain-of-thought user prompt.

In at least some instances, the explanation request step is performed as an evaluation because in some instances no explanation is produced for the selection of an atomic response. Thus, the explanation request step provides in some embodiments an additional metric to include for the trustworthiness metric. In this instance, a final validation score also takes into account the explanation score. The explanation score in an embodiment includes an explanation score whereby the explanation score is a fraction of a number of the atomic responses for which an explanation was identified divided by a total number of the atomic responses.

Chain of thought (“CoT”) prompting is an approach in artificial intelligence that simulates human-like reasoning processes by delineating complex tasks into a sequence of logical steps toward a final resolution. This methodology mimics a fundamental aspect of human intelligence, offering a structured mechanism for problem-solving. In other words, CoT is predicated on the cognitive strategy of breaking down elaborate problems into manageable, intermediate thoughts that sequentially lead to a conclusive answer.

CoT prompting goes beyond merely generating coherent and relevant responses and does so by requiring the AI to construct an entire logical argument, including premises and a conclusion, from scratch. While prompt chaining focuses on refining individual responses, CoT prompting aims to create a comprehensive and logically consistent argument, thereby pushing the boundaries of AI's problem-solving capabilities.

Chain of thought prompting is carried out by leveraging large language models (LLMs) to articulate a succession of reasoning steps, guiding the model toward generating analogous reasoning chains for novel tasks. This is achieved through exemplar-based prompts that illustrate the reasoning process, thus enhancing the model's capacity for addressing complex reasoning challenges.

In various embodiments, explanations produced via inputting the request for an explanation into the generative machine learning model are presented, e.g., via a user interface. In some instances, these explanations are presented along with the recommendations for operations.

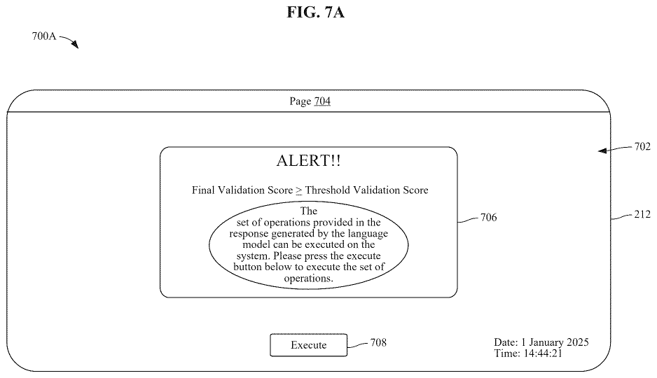

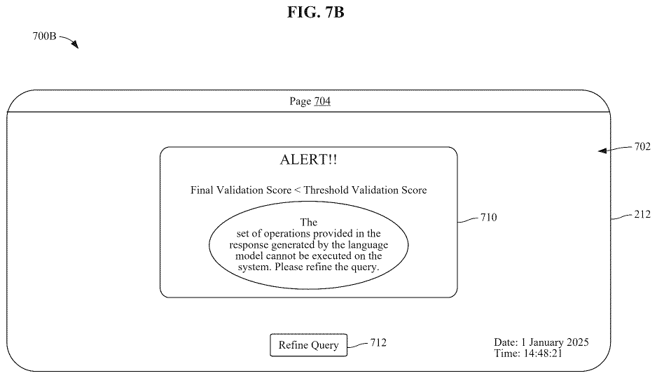

FIG. 7A is a diagram that illustrates an exemplary user interface (UI) for displaying a first recommendation associated with the response, in accordance with an embodiment of the disclosure. FIG. 7A is explained in conjunction with elements from FIG. 1, FIG. 2, FIG. 3, FIG. 4, FIG. 5A, FIG. 5B and FIG. 6. With reference to FIG. 7A, an exemplary diagram 700A includes an exemplary home screen 702 of the user device 212. The home screen 702 includes a page 704, a first UI element 706, and a second UI element 708. The page 704 corresponds to a web page that displays an alert based on a comparison of the final validation to the threshold validation value and includes date and time. The first UI element 706 is a text box that displays text such as the first recommendation associated with the response generated by the language model 206. The first recommendation was in this embodiment generated based on the final validation score being greater than or equal to the threshold validation value.

In an embodiment, the home screen 702 is part of the display interface of the user device 212 associated with the user 214. The system 202 calculates the final validation score associated with the response generated by the language model 206. The system 202 compares the final validation score with the threshold validation value. In an embodiment, the system 202 determines that the final validation score is greater than or equal to the threshold validation score. Based on the determination of the final validation score being greater than or equal to the threshold validation score, the system 202 renders (e.g., generates and presents, e.g., by displaying) the first recommendation as: “The set of operations provided in the response generated by the language model 206 can be executed on the system. Please press the execute button below to execute the set of operations”. Further, the second UI element 708 is labeled as “Execute”. Upon selection of the second UI element 708, the system 202 executes the set of operations that were/are provided in the response generated by the language model 206.

FIG. 7B is a diagram that illustrates another exemplary UI for displaying the second recommendation associated with the response generated by the language model, in accordance with an embodiment of the disclosure. FIG. 7B is explained in conjunction with elements from FIG. 1, FIG. 2, FIG. 3, FIG. 4, FIG. 5A, FIG. 5B, FIG. 6, and FIG. 7A. With reference to FIG. 7B, an exemplary diagram 700B includes an exemplary home screen 702 of a user device (e.g., the user device 212). The home screen 702 includes a page 704, a third UI element 710, and a fourth UI element 712. The page 704 is part of a web page to display an alert based on a comparison of the final validation to the threshold validation value and includes date and time. The third UI element 710 is a dialog box that presents a second recommendation associated with the response generated by the language model 206. The second recommendation is generated based on the final validation score being less than the threshold validation value.

In an embodiment, the home screen 702 is the display interface of the user device 212. The system 202 calculates the final validation score associated with the response generated by the language model 206. The system 202 compares the final validation score with the threshold validation value.

In an embodiment, the system 202 determines whether the final validation score is less than the threshold validation value. Based on a determination of the final validation score being less than the threshold validation value, the system 202 generates and presents, e.g., displays, the corresponding second recommendation: “The set of operations provided in the response generated by the language model cannot be executed on the system. Please refine the query.”. In an alternate embodiment, the second recommendation corresponds to restricting or eliminating a portion of the set of operations provided in the response to be executed on the system 202 to make a reduced set of operations. In an alternate embodiment, the second recommendation includes restricting or blocking some portion of any subsequent proactive approaches to improve the validation score such as query refinement for response generation or displaying individual scores associated with each atomic response or the entity action pair. Further, the fourth UI element 712 is a button labeled as “Refine Query”. Upon user selection/actuation of the fourth UI element 712, the system 202 modifies the query and inputs the modified query back into the language model 206.

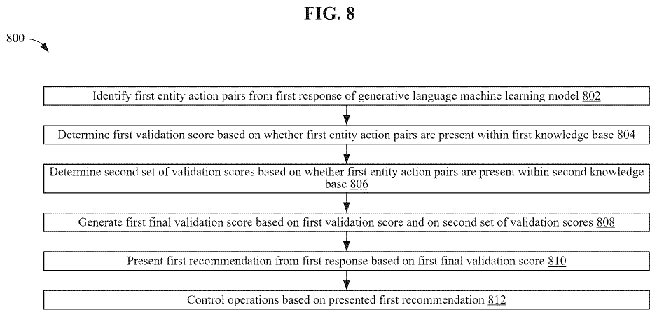

FIG. 8 is a diagram that illustrates a flowchart of an exemplary method for validation of domain-specific responses generated by the language model, in accordance with an embodiment of the disclosure. FIG. 8 is explained in conjunction with FIG. 1, FIG. 2, FIG. 3, and FIG. 4 FIG. 5A, FIG. 5B, FIG. 6, FIG. 7A and FIG. 7B. With reference to FIG. 8, there is shown a flowchart 800. The operations of the exemplary method can be executed by any computing system, for example, by the computer 102 of FIG. 1 or the system 202 of FIG. 2. The operations of the flowchart 800 starts at 802.

At 802, the first entity action pairs are identified from the first response of the generative language machine learning model. Each of the first entity action pairs include the respective entity and the respective action associated with the respective entity. In an embodiment of the disclosure, the system 202 identifies the first entity action pairs from the first response of the generative language machine learning model. Each of the first entity action pairs include the respective entity and the respective action associated with the respective entity. Details about the identification of the entity action pairs are provided, for example, in FIG. 3.

At 804, the first validation score is determined based on whether the first entity action pairs are present within a first knowledge base. In an embodiment of the disclosure, the system 202 determines the first validation score based on whether the first entity action pairs are present within a first knowledge base. Details about the determination of the first validation score are provided, for example in FIG. 2, FIG. 3, and FIG. 4.

At 806, the second set of validation scores is determined based on whether the first entity action pairs are present within a second knowledge base. In an embodiment of the disclosure, the system 202 determines the second set of validation scores based on whether the first entity action pairs are present within a second knowledge base. Details about the determination of the second set of validation scores are provided, for example, in FIG. 2, FIG. 3, FIG. 5A, and FIG. 5B.

At 808, the first final validation score is generated based on the first validation score and on the second set of validation scores. In an embodiment of the disclosure, the system 202 generates the first final validation score based on the first validation score and on the second set of validation scores. Details about the generation of the first final validation score are provided, for example, in FIG. 2, and FIG. 3.

At 810, the first recommendation is presented from the first response based on the first final validation score. In an embodiment of the disclosure, the system 202 presents the first recommendation from the first response based on the first final validation score. Details about the presentation of the first recommendation are provided, for example, in FIG. 2, FIG. 3, and FIG. 7A.

At 812, the operations are controlled based on the presented first recommendation. In an embodiment of the disclosure, the system 202 controls the operations based on the presented first recommendation. Details about the control of the operations are provided, for example, in FIG. 2, and FIG. 3. Based on the control of the operations, the operations of the flowchart ends.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
identifying, via machine learning, first entity action pairs from a first response of a generative language machine learning model, wherein each of the first entity action pairs comprises a respective entity and a respective action associated with the respective entity;
determining, via machine learning, a first validation score based on whether the first entity action pairs are present within a first knowledge base;
determining, via machine learning, a second set of validation scores based on whether the first entity action pairs are present within a second knowledge base;
generating a first final validation score based on the first validation score and on the second set of validation scores;
presenting a first recommendation from the first response based on the first final validation score; and
controlling, by a computer, operations based on the presented first recommendation.

2. The computer-implemented method of claim 1, further comprising:
decomposing, by machine learning, the first response into atomic responses, wherein each of the atomic responses includes at least one of the first entity action pairs;
determining, via machine learning, a second validation score based on whether the atomic responses are present within the first knowledge base; and
wherein the first final validation score is further based on the second validation score.

3. The computer-implemented method of claim 2, wherein the identifying of the first entity action pairs occurs via analyzing the atomic responses separately from each other.

4. The computer-implemented method of claim 2, wherein the determining of the second validation score comprises comparing first embeddings representing the atomic responses with second embeddings representing the first knowledge base, and wherein the second validation score corresponds to a similarity score produced by the comparing.

5. The computer-implemented method of claim 2, wherein the second validation score comprises a natural language inference score indicating a degree of entailment between the atomic responses and the first knowledge base.

6. The computer-implemented method of claim 2, further comprising:
assigning, by the computer, a respective one of a first label and a second label to each of the atomic responses based on whether the respective atomic response is present in the first knowledge base; and
determining, by the computer, the second validation score based on the assignment of the respective one of the first label and the second label.

7. The computer-implemented method of claim 1, wherein the first response was an output from the generative language machine learning model, wherein the output was produced in response to inputting a query into the generative language machine learning model.

8. The computer-implemented method of claim 7, wherein the query and the first response relate to an information technology (IT) domain.

9. The computer-implemented method of claim 7, further comprising retrieving the first knowledge base from one or more databases based on a specific domain of the query, wherein the first knowledge base comprises a source document associated with the specific domain, and wherein the determining the first validation score occurs based on whether the first entity action pairs are present within the source document.

10. The computer-implemented method of claim 7, wherein the second knowledge base comprises an ontology map associated with a specific domain associated with the query, and wherein the determining the second set of validation scores occurs based on whether the first entity action pairs are present within the ontology map.

11. The computer-implemented method of claim 1, wherein the controlling of the operations is performed in response to the first final validation score exceeding a predetermined threshold value.

12. The computer-implemented method of claim 1, further comprising:
identifying, via machine learning, second entity action pairs from a second response of the generative language machine learning model, wherein each of the second entity action pairs comprises a respective entity and a respective action associated with the respective entity, wherein the second response was an output from the generative language machine learning model, wherein the output was produced in response to inputting another query into the generative language machine learning model;
determining, via machine learning, an additional first validation score based on whether the second entity action pairs are present within the first knowledge base;
determining, via machine learning, an additional second set of validation scores based on whether the second entity action pairs are present within the second knowledge base;
generating a second final validation score based on the additional first validation score and on the additional second set of validation scores;
presenting a second recommendation based on the second final validation score, wherein the second recommendation indicates a modification for a query;
modifying the query according to the modification; and
inputting the modified query into the generative language machine learning model so that, in response, the generative language machine learning model outputs a new response.

13. The computer-implemented method of claim 1, wherein the first recommendation indicates the operations that are to be performed, and wherein the computer-implemented method further comprises:
in response to the presenting, receiving via a user interface a confirmation from a user to perform the operations, wherein the controlling the operations occurs in response to receiving the confirmation.

14. A computer system, comprising:
a processor set;
one or more computer-readable storage media; and
program instructions stored on the one or more computer-readable storage media, the program instructions executable by the processor set to cause the processor set to:
identify, via machine learning, first entity action pairs from a first response of a generative language machine learning model, wherein each of the first entity action pairs comprises a respective entity and a respective action associated with the respective entity;
determine, via machine learning, a first validation score based on whether the first entity action pairs are present within a first knowledge base;
determine, via machine learning, a second set of validation scores based on whether the first entity action pairs are present within a second knowledge base;
generate a first final validation score based on the first validation score and on the second set of validation scores;
present a first recommendation from the first response based on the first final validation score; and
control operations based on the presented first recommendation.

15. The computer system of claim 14, wherein the program instructions further cause the processor set to:
decompose, by machine learning, the first response into atomic responses, wherein each of the atomic responses includes at least one of the first entity action pairs;
determine, via machine learning, a second validation score based on whether the atomic responses are present within the first knowledge base; and
wherein the first final validation score is further based on the second validation score.

16. The computer system of claim 15, wherein the identification of the first entity action pairs occurs via an analysis of the atomic responses separately from each other.

17. The computer system of claim 15, wherein the determination of the second validation score comprises a comparison of first embeddings representing the atomic responses with second embeddings representing the first knowledge base, and wherein the second validation score corresponds to a similarity score produced by the comparison.

18. The computer system of claim 14, wherein the program instructions further cause the processor set to:
identify, via machine learning, second entity action pairs from a second response of the generative language machine learning model, wherein each of the second entity action pairs comprises a respective entity and a respective action associated with the respective entity, wherein the second response was an output from the generative language machine learning model, wherein the output was produced in response to inputting another query into the generative language machine learning model;
determine, via machine learning, an additional first validation score based on whether the second entity action pairs are present within the first knowledge base;
determine, via machine learning, an additional second set of validation scores based on whether the second entity action pairs are present within the second knowledge base;
generate a second final validation score based on the additional first validation score and on the additional second set of validation scores;
present a second recommendation based on the second final validation score, wherein the second recommendation indicates a modification for the query;
modify the query according to the modification; and
input the modified query into the generative language machine learning model so that, in response, the generative language machine learning model outputs a new response.

19. The computer system of claim 14, wherein the first recommendation indicates the operations that are to be performed, and wherein the program instructions further cause the processor set to:
in response to the presentation, receive, via a user interface, a confirmation from a user to perform the operations, wherein the control of the operations occurs in response to receiving the confirmation.

20. A computer-program product for a validation of a response generated by a language model, the computer-program product comprising:
one or more computer-readable storage media; and
program instructions stored on the one or more computer-readable storage media to perform operations comprising:
identifying, via machine learning, first entity action pairs from a first response of a generative language machine learning model, wherein each of the first entity action pairs comprises a respective entity and a respective action associated with the respective entity;
determining, via machine learning, a first validation score based on whether the first entity action pairs are present within a first knowledge base;
determining, via machine learning, a second set of validation scores based on whether the first entity action pairs are present within a second knowledge base;
generating a first final validation score based on the first validation score and on the second set of validation scores;
presenting a first recommendation from the first response based on the first final validation score; and
controlling operations based on the presented first recommendation.
